(19) United States
(12) Patent Application Publication
(10) Pub. No.: US 2014/0114646 A1
(43) Pub. Date: Apr. 24, 2014

(54) CONVERSATION ANALYSIS SYSTEM FOR SOLUTION SCOPING AND POSITIONING

(71) Applicant: SAP AG, Walldorf (DE)

(72) Inventor: Oleg Figlin, London (GB)

(73) Assignee: SAP AG, Walldorf (DE)

(21) Appl. No.: 13/659,159

(22) Filed: Oct. 24, 2012

(51) Int. Cl. G06F 17/27; G10L 15/04

(52) U.S. Cl. 704/9; 704/251; 704/E15.005

(57) ABSTRACT

A system receives vocal input from one or more persons, and extracts one or more keywords from the vocal input. The system then generates a query using the one or more keywords, searches a database of products and services using the query, and identities a product or service as a function of the query.

### TECHNICAL FIELD

The present disclosure relates to a conversation analysis system for solution scoping and positioning.

### BACKGROUND

There are basically two key sales techniques currently used by business organizations. The first is referred to as the Push technique, and the second is referred to as the Pull technique. The Push technique refers to cases wherein a business organization positions specific products, solutions, or portfolios of products to customers. However, many customers have very clear requirements, which may not be met or may not be completely met by a business organization's current products. The business organization can then develop new products or modify its current products to meet the requirements of the customer. This is then referred to as the Pull technique.

Notwithstanding the use of the Push technique or the Pull technique, or the use of a combination of the two, in many cases, either during events or regular discussions with prospects and customers, sales representatives struggle to identify possible solutions to the customer's requirements on the fly. This can particularly be the case when the business organization has an extensive product and service portfolio.

### BRIEF DESCRIPTION OF THE DRAWINGS

FIGS. 1A and 1B are a flowchart-like block diagram illustrating steps and features of a process to use conversation analysis in solution scoping and positioning.

FIG. 2 is an example output of a conversation analysis system for solution scoping and positioning.

FIG. 3 is a block diagram of an example embodiment of a computer system upon which one or more embodiments of the present disclosure can execute.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In an embodiment, a system, method, computer readable medium, and/or a mobile device assist a sales representative in identifying products and services that prospects or customers require. In some instances, this assistance is provided without even requiring the sales representative to touch his or her mobile device or laptop. For example, the sales representative can ask the prospect or customer what he or she is interested in, and the mobile device interprets the response of the customer or prospect and displays a solution and other information such as demonstrations of the product. This permits the sales representative to scope customer requirements without going through multiple screens and options, but rather just by talking to the customer and having the mobile device interpret and respond to the discussion.

More specifically, an embodiment includes a sales application based on the recognition of key terms or key words. A sales representative's mobile device ‘listens’ to a conversation between the sales representative and the customer, filters the language of the sales representative and the customer, and recognizes business terminology and the requirements of the customer. This business terminology is then used to construct a query and automatically search through a product and service database portfolio and present solutions to the customer. The product and service database portfolio can either be resident on the mobile device or can be remote and the mobile device can access the portfolio via a communication link. The application on the mobile device works in the background while the sales representative conducts a normal conversation with the customer. This normal conversation may include a discussion of the customer's existing business pain points, value drivers, or other issues. The device query will then locate products and services that will address these pain points of the customer. In a particular application of such a conversation analysis system, the sales representative can represent a software vendor, and the products and services can related to software products and services.

Once the customer is interested in a specific solution, the mobile device can scope customer requirements to a greater extent by ‘listening’ to additional customer requirements (e.g., business processes and non-process related requirements like trainings, upgrades, etc.) and automatically scope it in the system. As noted, the sales representative and the customer conduct a normal conversation while the mobile device translates human language into business and technical requirements and links these requirements to products and services that ears be offered. This application can be used during an opportunity generation phase as well as during a more detailed bid process.

Embodiments have several advantages. First, requirements are more easily captured and solutions more easily identified since, in an embodiment, not a single button or screen needs to be touched on the mobile device. Second, opportunities can be generated automatically by the mobile device without the sales representative even recognizing it. Third, no matter whom the sales representative talks to (different professionals use different terminology and business language), the system translates the language and terminology into business requirements and maps them to real solutions.

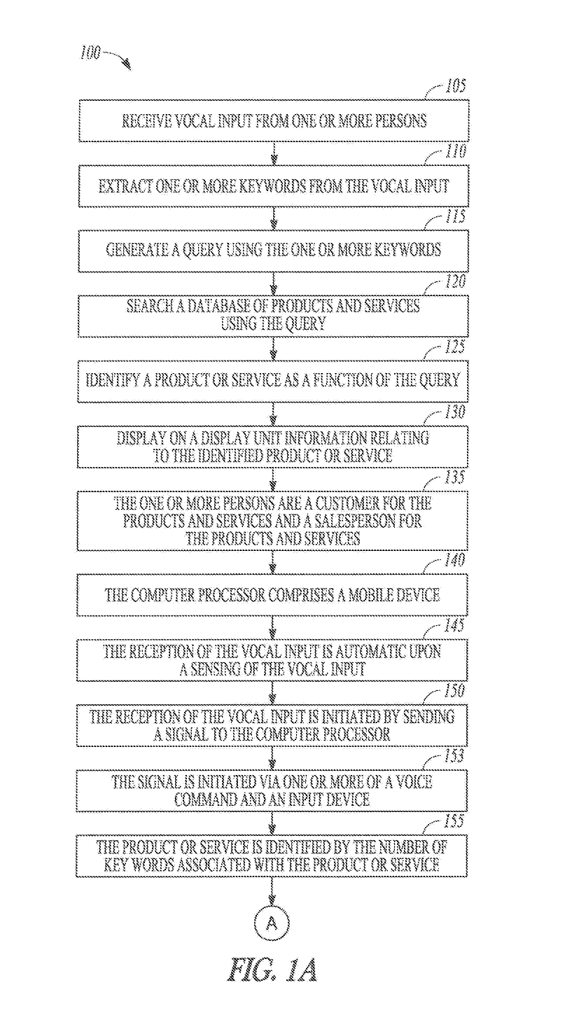

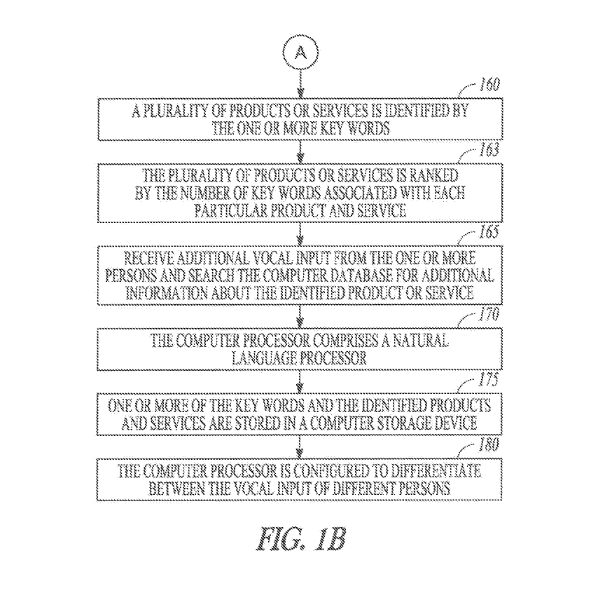

FIGS. 1A and 1B are a flowchart of an example process 100 for analyzing a conversation for solution scoping and positioning. FIGS. 1A and 1B include a number of process blocks 105-180. Though arranged serially in the example of FIGS. 1A and 1B, other examples may reorder the blocks, omit one or mote blocks, and/or execute two or mere blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now specifically to FIGS. 1A and 1B, at 105, vocal input from one or more persons is received into a computer processor. At 110, one or more keywords are extracted from the vocal input. At 115, a query is generated using the one or more keywords. At 120, a database of products and services is searched using the query. At 125, a product or service is identified as a function of the query.

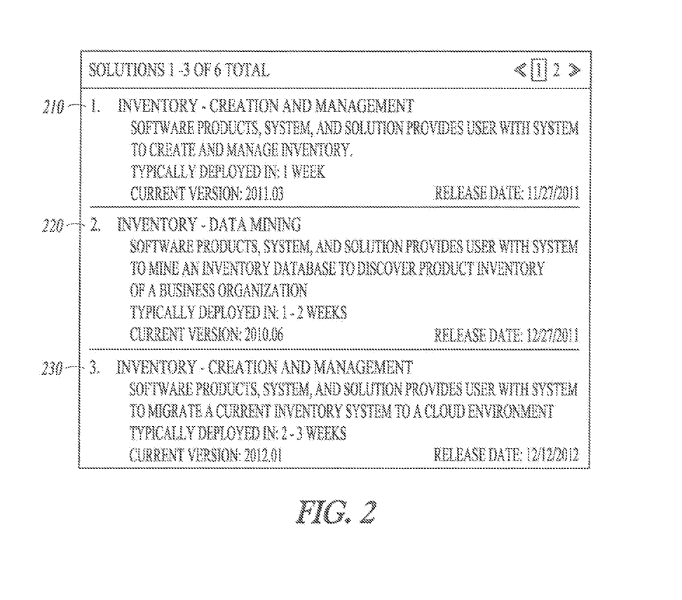

At 130, the information relating to the identified product or service is displayed on a display unit. The display unit can be part of virtually any computer-based electronic device, and in particular, as indicated as 140, a mobile device such as a hand-held device or a lap top computer. FIG. 2 illustrates an example of such a display on a display unit. Specifically, FIG. 2 illustrates a result of a conversation analysis that has located six products or services based on an analysis of a conversation between a sales representative and a customer. FIG. 2 illustrates a display of the first three results on a first screen. The first three results illustrated in FIG. 2 relate to inventory software systems, and in particular the creation and management of an inventory software system (210), data mining in an inventory software system (220), and exporting an inventory software system to a cloud platform (230).

At 135, the one or more persons are a customer for the products and services and a salesperson for the products and services. So as noted above, such a device is useful for a sales representative for a business organization when that sales representative makes a sales call on a customer. The sales representative can hold a normal conversation with the customer, and let his mobile device receive the vocal input from the customer, interpret and extract business-oriented keywords from that input, search a product and service database using those keywords, and generate a list of products and services based on those identified keywords. The sales representative's device will of course also sense and receive the vocal input from the sales representative. Consequently, if the sales representative knows of a product or service that would be of interest to the customer, the sales representative can mention that product or service, and the mobile device will retrieve information from the database on that product or service.

At 145, the reception of the vocal input is automatic upon a sensing of the vocal input by the computer processor of the mobile device. Alternatively, as illustrated at 150, the reception of the vocal input is initiated by sending a signal to the computer processor of the mobile device. At 153, such a signal is initiated by a voice command or an input actuator that is on the device. The voice command can be something as simple as “Start Operation” spoken by the sales representative. The input actuator can be for example a button on the mobile device or an icon on the screen of the mobile device.

At 155, the product or service is identified by the number of keywords associated with the product or service. For example, the mobile device cars be configured to keep a running tally of the number of times that each identified keyword is mentioned, and then to retrieve information based on any such keyword only if the keyword is mentioned a minimum number of times. Such a configuration assures that only the most discussed areas of concern are used to search for products and services, and that topics that are only minimally touched upon do not overpopulate the search results.

At 160, a plurality of products or services is identified by the one or more keywords. When several products or services are identified as a result of the search of the database, this of course provides the customer with the most options, and provides the sales representative with the most sales opportunities. At 163, the plurality of products or services is ranked by the number of keywords associated with each particular product and service. Such a ranking places the products and services that are probably the most important or critical at the forefront for easy identification by the sales representative.

At 165, the computer processor of the mobile device is configured to receive additional vocal input from the one or more persons, and to search the computer database for additional information about the identified product or service. That is, the mobile device can be configured to execute follow up searches of the database with additional vocal input. These additional follow up searches may return additional information about the previously retrieved products and services, information about related products and services, and/or any other type of relevant product and service information. A filter can be applied to the search results so that duplicate results are not reported.

At 170, the computer processor of the mobile device includes a natural language processor. The natural language processor parses the vocal input to identify the keywords. At 175, the keywords and the identified products and services are stored in a computer storage device. This permits the sales representative to have a record of the sales call and the results of the search initiated by the sales call for later retrieval, analysis, and sales call report generation. At 180, the computer processor of the sales call device is configured to differentiate between the vocal input of different persons. That is, the mobile device includes a voice recognition system. This ability to distinguish between the vocal input of the sales representative and the customer can be used in several ways. For example, if the customer is talking about a particular need of his or her business organization, but is not using the most appropriate terminology, the sales representative can chime in by using what he or she feels is the correct terminology. Then, the mobile device can be configured to search first and foremost on the keywords indentified in the vocal input of the sales representative, thereby generating a more useful search.

### Example Embodiments

Example No. 1 is a system comprising a computer processor configured to receive vocal input from one or more persons; extract one or more keywords from the vocal input; generate a query using the one or mote keywords; search a database of products and services using the query; and identity a product or service as a function of the query.

Example No. 2 includes the features of Example No. 1 and optionally includes a system wherein the computer processor is configured to display on a display unit one or more of information relating to the identified product or service and a demonstration of the identified product or service.

Example No. 3 includes the features of Example Nos. 1-2 and optionally includes a system wherein the one or more persons are a customer for the products and services and a salesperson for the products and services.

Example No. 4 includes the features of Example Nos. 1-3 and optionally includes a system wherein the computer processor comprises a mobile device.

Example No. 5 includes the features of Example Nos. 1-4 and optionally includes a system wherein the reception of the vocal input is automatic upon a sensing of the vocal input.

Example No. 6 includes the features of Example Nos. 1-5 and optionally includes a system wherein the reception of the vocal input is initiated by sending a signal to the computer processor.

Example No. 7 includes the features of Example Nos. 1-6 and optionally includes a system wherein the signal is initiated via one or more of a voice command and an input device.

Example No. 8 includes the features of Example Nos. 1-7 and optionally includes a system wherein the product or service is identified by the number of key words associated with the product or service.

Example No. 9 includes the features of Example Nos. 1-8 and optionally includes a system wherein a plurality of products or services is identified by the one or more key words.

Example No. 10 includes the features of Example Nos. 1-9 and optionally includes a system wherein the plurality of products or services is ranked by the number of key words associated with each particular product and service.

Example No. 11 includes the features of Example Nos. 1-10 and optionally includes a system wherein the computer processor is configured to receive additional vocal input from the one or more persons, and to search the computer database for additional information about the identified product or service.

Example No. 12 includes the features of Example Nos. 1-11 and optionally includes a system wherein the computer processor comprises a natural language processor.

Example No. 13 includes the features of Example Nos. 1-12 and optionally includes a system wherein one or more of the key words and the identified products and services are stored in a computer storage device.

Example No. 14 includes the features of Example Nos. 1-13 and optionally includes a system wherein the computer processor is configured to differentiate between the vocal input of different persons.

Example No. 15 includes a process comprising receiving into a mobile device vocal input from one or more persons; extracting one or more keywords from the vocal input; generating a query using the one or more keywords; searching a database of products and services using the query; and identifying a product or service as a function of the query.

Example No. 16 includes the features of Example No. 15 and optionally includes a process comprising displaying on a display unit one or more of information relating to the identified product or service and a demonstration of the identified product or service.

Example No. 17 includes the features of Example Nos. 15-16 and optionally includes a process comprising identifying the product or service by the number of key words associated with the product or service.

Example No. 18 includes a computer readable storage device comprising instructions that when executed by a processor execute a process comprising receiving into a mobile device vocal input from one or more persons; extracting one or more keywords from the vocal input; generating a query using the one or more keywords; searching a database of products and services using the query; and identifying a product or service as a function of the query.

Example No. 19 includes the features of Example No. 18 and optionally includes a computer readable medium comprising instructions for identifying a plurality of products or services by the one or more key words; and comprising instructions for ranking the products and services by the number of key words associated with each particular product and service.

Example No. 20 includes the features of Example Nos. 18-19 and optionally includes a computer readable medium comprising instructions for receiving additional vocal input from the one or more persons, and for searching the computer database for additional information about the identified product or service.

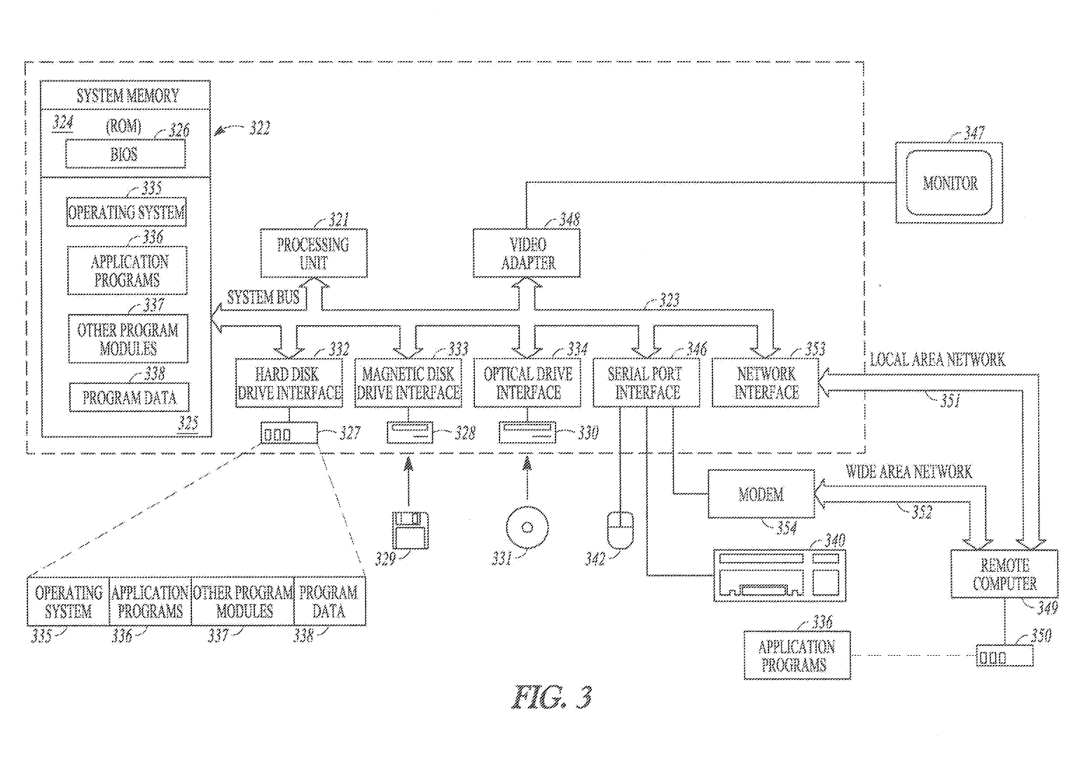

FIG. 3 is an overview diagram of hardware and an operating environment in conjunction with which embodiments of the invention may be practiced. The description of FIG. 3 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 3, a hardware and operating environment is provided that is applicable to any of the servers and/or remote clients shown in the other Figures.

As shown in FIG. 3, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 47 can display a graphical user interface for the user. In addition to the monitor 47, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 3 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

Thus, an example system, method and machine readable medium for interactive solution positioning and scoping have been described. Although specific example embodiments have been described, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a computer processor configured to:
receive vocal input from one or more persons;
extract one or more keywords from the vocal input;
generate a query using the one or more keywords;
search a database of products and services using the query; and
identify a product or service as a function of the query.

2. The system of claim 1, wherein the computer processor is configured to display on a display unit one or more of information relating to the identified product or service and a demonstration of the identified product or service.

3. The system of claim 1, wherein the one or more persons are a customer for the products and services and a salesperson for the products and services.

4. The system of claim 1, wherein the computer processor comprises a mobile device.

5. The system of claim 1, wherein the reception of the vocal input is automatic upon a sensing of the vocal input.

6. The system of claim 1, wherein the reception of the vocal input is initiated by sending a signal to the computer processor.

7. The system of claim 6, wherein the signal is initiated via one or more of a voice command and an input device.

8. The system of claim 1, wherein the product or service is identified by the number of key words associated with the product or service.

9. The system of claim 1, wherein a plurality of products or services is identified by the one or more key words.

10. The system of claim 9, wherein the plurality of products or services is ranked by the number of key words associated with each particular product and service.

11. The system of claim 1, wherein the computer processor is configured to receive additional vocal input from the one or more persons, and to search the computer database for additional information about the identified product or service.

12. The system of claim 1, wherein the computer processor comprises a natural language processor.

13. The system of claim 1, wherein one or more of the key words and the identified products and services are stored in a computer storage device.

14. The system of claim 1, wherein the computer processor is configured to differentiate between the vocal input of different persons.

15. A process comprising:
receiving into a mobile device vocal input from one or more persons;
extracting one or more keywords from the vocal input:
generating a query using the one or more keywords;
searching a database of products and services using the query; and
identifying a product or service as a function of the query.

16. The process of claim 15, comprising displaying on a display unit one or more of information relating to the identified product or service and a demonstration of the identified product or service.

17. The process of claim 15, comprising identifying the product or service by the number of keywords associated with the product or service.

18. A computer readable storage device comprising instructions that when executed by a processor execute a process comprising:
receiving into a mobile device vocal input from one or more persons;
extracting one or more keywords from the vocal input;
generating a query using the one or more keywords;
searching a database of products and services using the query; and
identifying a product or service as a function of the query.

19. The computer readable storage device of claim 18, comprising instructions for identifying a plurality of products or services by the one or more keywords; and comprising instructions tor ranking the products and services by the number of keywords associated with each particular product and service.

20. The computer readable storage device of claim 18, comprising instructions for receiving additional vocal input from the one or more persons, and for searching the computer database for additional information about the identified product or service.
